(19) United States
(12) Patent Application Publication
(10) Pub. No.: US 2009/0303000 A1
(43) Pub. Date: Dec. 10, 2009

(54) Linearisation of Scanned Data

(75) Inventors: Russell Paul Cowburn, London (GB); James David Ralph Buchanan, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ingenia Holdings (UK) Limited, London (GB)

(21) Appl. No.: 12/471,212

(22) Filed: May 22, 2009

Related U.S. Application Data
(60) Provisional application No. 61/055,766, filed on May 23, 2008.

(30) Foreign Application Priority Data
May 23, 2008 (GB) 0809502.8

(51) Int. Cl. G06F 7/04; H04N 1/40

(52) U.S. Cl. 340/5.86; 358/448

(57) ABSTRACT

A system for obtaining a signature a scan area on the surface of an article comprises: a signature generator that generates the signature from scattered coherent radiation detected from a plurality of regions on the surface by using relative motion between the article and a scan head comprising a coherent radiation source and photodetectors to obtain a set of data points comprising a group of data points from each region; an imaging detector that captures a sequence of images of the surface during the relative motion; and a processor that calculates the instantaneous velocity of the relative motion; whereby the signature generator uses the instantaneous velocity to linearise the groups of data point within the set of data points before generating the signature of the article from the set of data points.

### CROSS-REFERENCE TO RELATED APPLICATIONS

This application is based upon and claims the benefit of priority from the prior U.S. Patent Application No. 61/055,766, filed May 23, 2008, and prior GB Patent Application No. 0809502.8, filed May 23, 2008 both of which are hereby incorporated herein by reference in their entirety.

### BACKGROUND OF THE INVENTION

The present invention relates to a scanner for obtaining a signature from an article which can be used for authentication of the article, and a method for obtaining such a signature.

Many traditional authentication systems rely on a process which is difficult for anybody other than the manufacturer to perform, where the difficulty may be imposed by expense of capital equipment, complexity of technical know-how or preferably both. Examples are the provision of a watermark in bank notes and a hologram on credit cards or passports. Unfortunately, criminals are becoming more sophisticated and can reproduce virtually anything that original manufacturers can do. Furthermore, such systems are typically too expensive and complicated for tasks such as product tracking for quality control and warranty purposes.

Because of this, there is a known approach to authentication systems which relies on creating security tokens using some process governed by laws of nature which results in each token being unique, and more importantly having a unique characteristic that is measurable and can thus be used as a basis for subsequent verification. According to this approach tokens are manufactured and measured in a set way to obtain a unique characteristic. The characteristic can then be stored in a computer database, or otherwise retained. Tokens of this type can be embedded in the carrier article, e.g. a banknote, passport, ID card, important document. Subsequently, the carrier article can be measured again and the measured characteristic compared with the characteristics stored in the database to establish if there is a match. However, such systems are often still too expensive and/or complicated for tasks such as product tracking for quality control and warranty purposes.

James D. R. Buchanan et al in “Forgery: ‘Fingerprinting’ documents and packaging”, Nature 436, 475-475 (28 Jul. 2005) describes a system for using reflected laser light from an article to uniquely identify the article with a high degree of reproducibility not previously attained in the art. Buchanan's technique samples reflections from an article surface a number of times at each of multiple points in the surface to create a signature or “fingerprint” for the article.

Identification methods which measure reflected light typically require either or both of the light source and the light detector to be scanned relative to the article, so that a defined area of the article's surface is measured. The accuracy of the identification depends in part on the scan rate being approximately the same for both the original scanning of the article's characteristics and the subsequent scanning used to identify the article. Any variations in the scan rate for the subsequent scanning can produce a scan output which is distorted compared to the original scan, making matching of the scan output to the original scan data difficult. This can result in the rejection of an authentic article. The present invention addresses this problem.

### SUMMARY OF THE INVENTION

Accordingly, a first aspect of the present invention is directed to a system for obtaining a signature from an article, the article having a scan area on a surface of the article from which a signature of the article may be read, the system comprising: a signature generator including a scan head comprising an optical source operable to direct coherent radiation onto the scan area and a detector arrangement operable to detect the coherent radiation scattered from the scan area, the signature generator operable to generate a signature from the article by: directing coherent radiation sequentially onto a plurality of different regions in the scan area using relative motion between the scan head and the article; for each region, collecting a group of data points from signals obtained by detecting the coherent radiation scattered from that region, the groups of data points together comprising a set of data points; and determining a signature of the article from the set of data points; a second optical source operable to direct illuminating radiation onto the surface of the article; an imaging detector operable to receive the illuminating radiation returned from the surface of the article and to capture a sequence of images of the surface of the article during collection of the set of data points, the images captured at known times; and a processor operable to calculate the instantaneous velocity of the relative motion between the scan head and the article during the collection of the set of data points from the captured images, and to provide the instantaneous velocity to the signature generator; the signature generator being further operable to use the instantaneous velocity to linearise the positions of the groups of data points within the set of data points before determining the signature of the article.

By determining the instantaneous velocity over the course of scanning the article to read its signature, any deviations from a constant velocity which would otherwise distort the scan data can be corrected for. The velocity can be calculated from a sequence of images of the article's surface in a straightforward manner, and this is a convenient technique for measuring velocity in the present case, since the signature generation already relies on directing radiation onto the article and detecting returned illumination.

In some embodiments, the image detector captures the images at a constant frame rate, and the groups of data points are collected at a constant rate. This simplifies the determination of the instantaneous velocity and the subsequent linearisation. However, non-constant rates may also be used.

The linearisation may comprise adjusting the spacing of the groups of data points within the set of data points in proportion to the calculated instantaneous velocity. A scaling factor can be derived directly from the instantaneous velocity and applied to a default constant spacing of the data groups to adjust the positions of the groups to properly reflect the velocity at which the data groups were collected.

Further, both the instantaneous velocity and a velocity of the relative motion recorded during an earlier obtaining of a signature from an article may be used to linearise the positions of the groups of data points within the set of data points. This can compensate for any differences in the overall relative velocity compared to the velocity at which an earlier signature was obtained. The current signature is hence scaled to match the size of the earlier signature. Comparison of the signatures for authentication purposes is thereby facilitated.

The illuminating radiation may be coherent radiation and the imaging detector may capture images of speckle or other surface information type data. Alternatively, the second optical source may comprise one or more light emitting diodes, in which case the illuminating radiation is non-coherent.

The coherent radiation from the optical source and the illuminating radiation from the second optical source may have different wavelengths. This can help to differentiate between the two, so that the signature data and the images can be detected without contamination or interference by radiation used for the other.

The system may further comprise: a signature comparator operable to compare the signature of the article with one or more stored signatures of articles; and a determiner operable to determine an authentication result based on the result of the comparison by the signature comparator.

A second aspect of the present invention is directed to a method for obtaining a signature from an article, the article having a scan area on a surface of the article from which a signature of the article may be read, the method comprising: obtaining a set of data points by: directing coherent radiation sequentially onto a plurality of different regions in the scan area using relative motion between the article and a scan head comprising an optical source operable to direct the coherent radiation onto the scan area and a detector arrangement operable to detect the coherent radiation scattered from the scan area; and, for each region, collecting a group of data points from signals obtained by detecting the coherent radiation scattered from that region, the groups of data points together comprising a set of data points; during collection of the set of data points, directing illuminating radiation onto the surface of the article and capturing at known times a sequence of images of the surface of the article by detecting the illuminating radiation returned from the surface; calculating the instantaneous velocity of the relative motion between the scan head and the article during the collection of the set of data points from the captured images; using the instantaneous velocity to linearise the positions of the groups of data points within the set of data points; and determining a signature of the article from the set of data points.

### BRIEF DESCRIPTION OF THE DRAWINGS

For a better understanding of the invention and to show how the same may be carried into effect reference is now made by way of example to the accompanying drawings in which:

FIG. 1 shows a schematic side view of a reader apparatus;

FIG. 2 shows a block schematic diagram of functional components of the reader apparatus of FIG. 1;

FIG. 3 is a microscope image of a paper surface;

FIG. 4 shows an equivalent image for a plastic surface;

FIG. 5 shows a flow diagram showing how a signature of an article can be generated from a scan;

FIG. 6 is a flow diagram showing how a signature of an article obtained from a scan can be verified against a signature database;

FIGS. 7a and 7b are plots illustrating how a number of degrees of freedom can be calculated;

FIG. 8 is a flow diagram showing the overall process of how a document is scanned for verification purposes and the results presented to a user;

FIG. 9 shows a schematic representation of part of an apparatus according to an embodiment of the invention;

FIG. 10 shows a schematic representation of a further part of the apparatus of FIG. 9;

FIG. 11 shows a plan view of part of the apparatus of FIG. 9;

FIG. 12 shows a representation of a scan area on an article from which a signature can be read using the apparatus of FIG. 9; and

FIGS. 13A-13D illustrate features of a method of reading a signature according to an embodiment of the invention.

While the invention is susceptible to various modifications and alternative forms, specific embodiments are shown by way of example in the drawings and are herein described in detail. It should be understood, however, that the drawings and detailed description are not intended to limit the invention to the particular form disclosed, but on the contrary, the invention is to cover all modifications, equivalents and alternatives falling within the spirit and scope of the present invention as defined in the appended claims.

### DETAILED DESCRIPTION

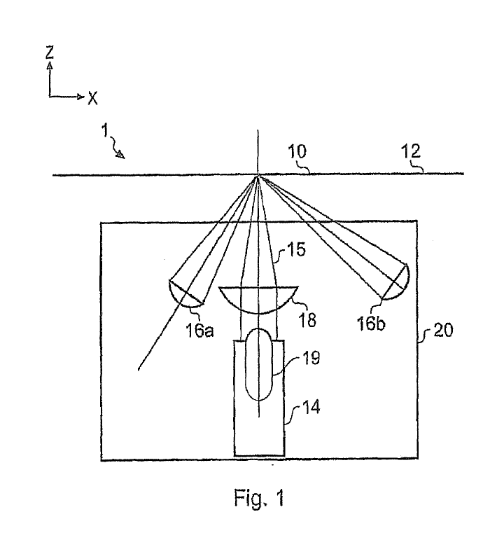

To provide an accurate method for uniquely identifying an article, it is possible to use a system which relies upon optical reflections from a surface of the article. An example of such a system will be described with reference to FIGS. 1 to 10.

The example system described herein is one developed and marketed by Ingenia Technologies Ltd. This system is operable to analyse the random surface patterning of a paper, cardboard, plastic or metal article, such as a sheet of paper, an identity card or passport, a security seal, a payment card etc to uniquely identify a given article. This system is described in detail in a number of published patent applications, including GB0405641.2 filed 12 Mar. 2004 (published as GB2411954 14 Sep. 2005), GB0418138.4 filed 13 Aug. 2004 (published as GB2417707 8 Mar. 2006), U.S. 60/601,464 filed 13 Aug. 2004, U.S. 60/601,463 filed 13 Aug. 2004, U.S. 60/610,075 filed 15 Sep. 2004, GB 0418178.0 filed 13 Aug. 2004 (published as GB2417074 15 Feb. 2006), U.S. 60/601,219 filed 13 Aug. 2004, GB 0418173.1 filed 13 Aug. 2004 (published as GB2417592 1 Mar. 2006), U.S. 60/601,500 filed 13 Aug. 2004, GB 0509635.9 filed 11 May 2005 (published as GB2426100 15 Nov. 2006), U.S. 60/679,892 filed 11 May 2005, GB 0515464.6 filed 27 Jul. 2005 (published as GB2428846 7 Feb. 2007), U.S. 60/702,746 filed 27 Jul. 2005, GB 0515461.2 filed 27 Jul. 2005 (published as GB2429096 14 Feb. 2007), U.S. 60/702,946 filed 27 Jul. 2005, GB 0515465.3 filed 27 Jul. 2005 (published as GB2429092 14 Feb. 2007), U.S. 60/702,897 filed 27 Jul. 2005, GB 0515463.8 filed 27 Jul. 2005 (published as GB2428948 7 Feb. 2007), U.S. 60/702,742 filed 27 Jul. 2005, GB 0515460.4 filed 27 Jul. 2005 (published as GB2429095 14 Feb. 2007), U.S. 60/702,732 filed 27 Jul. 2005, GB 0515462.0 filed 27 Jul. 2005 (published as GB2429097 14 Feb. 2007), U.S. 60/704,354 filed 27 Jul. 2005, GB 0518342.1 filed 8 Sep. 2005 (published as GB2429950 14 Mar. 2007), U.S. 60/715,044 filed 8 Sep. 2005, GB 0522037.1 filed 28 Oct. 2005 (published as GB2431759 02 May 2007), and U.S. 60/731,531 filed 28 Oct. 2005 (all invented by Cowburn et al.), the content of each and all of which is hereby incorporated hereinto by reference.

By way of illustration, a brief description of the method of operation of the Ingenia Technologies Ltd system will now be presented.

FIG. 1 shows a schematic side view of an example of a reader apparatus or scanner apparatus 1. The optical reader apparatus 1 is for measuring a signature from an article (not shown) arranged in a reading volume of the apparatus. The reading volume is formed by a reading aperture 10 which is a slit in a housing 12. The housing 12 contains the main optical components of the apparatus. The slit has its major extent in the x direction (see inset axes in the drawing). The principal optical components are a laser source 14 for generating a coherent laser beam 15 and a detector arrangement 16 made up of a plurality of k photodetector elements, where k=2 in this example, labelled 16a and 16b. The laser beam 15 is focused by a focussing arrangement 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly, scan assembly or scan head 20. In the illustrated example, the detector elements 16a, 16b are distributed either side of the beam axis offset at different angles from the beam axis to collect light scattered in reflection from an article present in the reading volume. In one example, the offset angles are −30 and +50 degrees. The angles either side of the beam axis can be chosen so as not to be equal so that the data points they collect are as independent as possible. However, in practice, it has been determined that this is not essential to the operation and having detectors at equal angles either side of the incident beam is a perfectly workable arrangement. In examples having more than two detector elements (k>2), all the detector elements may be arranged in a common plane. The photodetector elements 16a and 16b detect light scattered from an article placed on the housing when the coherent beam scatters from the reading volume. As illustrated, the source is mounted to direct the laser beam 15 with its beam axis in the z direction, so that it will strike an article in the reading volume at normal incidence.

Generally it is desirable that the depth of focus is large, so that any differences in the article positioning in the z direction do not result in significant changes in the size of the beam in the plane of the reading aperture. In one example, the depth of focus is approximately ±2 mm which is sufficiently large to produce good results. In other arrangements, the depth of focus may be greater or smaller. The parameters of depth of focus, numerical aperture and working distance are interdependent, resulting in a well known trade-off between spot size and depth of focus. In some arrangements, the focus may be adjustable, and in conjunction with a range-finding means the focus may be adjusted to target an article placed within an available focus range.

In order to enable a number of points on the target article to be read (scanning the article), the article and reader apparatus can be arranged so as to permit the incident beam and associated detectors to move relative to the target article. This can be arranged by moving the article, the scan assembly or both. In some examples, the article may be held in place adjacent the reader apparatus housing and the scan assembly may move within the reader apparatus to cause this movement. Alternatively, the article may be moved past the scan assembly, for example in the case of a production line where an article moves past a fixed position scanner while the article travels along a conveyor. In other alternatives, both article and scanner may be kept stationary, while a directional focus means causes the coherent light beam to travel across the target. This may require the detectors to move with the light beam, or stationary detectors may be positioned so as to receive reflections from all incident positions of the light beam on the target.

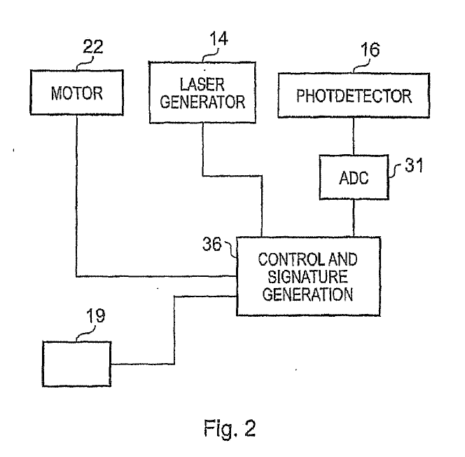

FIG. 2 is a block schematic diagram of logical components of a reader apparatus as discussed above. A laser generator 14 is controlled by a control and signature generation unit 36. Optionally, a motor 22 may also be controlled by the control and signature generation unit 36. Optionally, if some form of motion detection or linearization means (shown as 19) is implemented to measure motion of the target past the reader apparatus, and/or to measure and thus account for non-linearities in their relative movement, this can be controlled using the control and signature generation unit 36.

The reflections of the laser beam from the target surface scan area are detected by the photodetector 16. As discussed above, more than one photodetector element may be provided in some examples. The output from the photodetector 16 is digitised by an analog to digital converter (ADC) 31 before being passed to the control and signature generation unit 36 for processing to create a signature for a particular target surface scan area. The ADC can be part of a data capture circuit, or it can be a separate unit, or it can be integrated into a microcontroller or microprocessor of the control and signature generation unit 36.

The control and signature generation unit 36 can use the laser beam present incidence location information to determine the scan area location for each set of photodetector reflection information. Thereby a signature based on all or selected parts of the scanned part of the scan area can be created. Where less than the entire scan area is being included in the signature, the signature generation unit 36 can simply ignore any data received from other parts of the scan area when generating the signature. Alternatively, where the data from the entire scan area is used for another purpose, such as positioning or gathering of image-type data from the target, the entire data set can be used by the control and signature generation unit 36 for that additional purpose and then kept or discarded following completion of that additional purpose.

As will be appreciated, the various logical elements depicted in FIG. 2 may be physically embodied in a variety of apparatus combinations. For example, in some situations, all of the elements may be included within a reader apparatus. In other situations, the reader apparatus may include only the laser generator 14, motor 22 (if any) and photodetector 16 with all the remaining elements being located in a separate physical unit or units. Other combinations of physical distribution of the logical elements can also be used. Also, the control and signature generation unit 36 may be split into separate physical units. For example, there may be a first unit which actually controls the laser generator 14 and motor (if any), a second unit which calculates the laser beam current incidence location information, a third unit which identifies the scan data which is to be used for generating a signature, and a fourth part which actually calculates the signature.

It will be appreciated that some or all of the processing steps carried out by the ADC 31 and/or the control and signature generation unit 36 may be carried out using a dedicated processing arrangement such as an application specific integrated circuit (ASIC) or a dedicated analog processing circuit. Alternatively or in addition, some or all of the processing steps carried out by the beam ADC 31 and/or control and signature generation unit 36 may be carried out using a programmable processing apparatus such as a digital signal processor or multi-purpose processor such as may be used in a conventional personal computer, portable computer, handheld computer (e.g. a personal digital assistant or PDA) or a smartphone. Where a programmable processing apparatus is used, it will be understood that a software program or programs may be used to cause the programmable apparatus to carry out the desired functions. Such software programs may be embodied onto a carrier medium such as a magnetic or optical disc or onto a signal for transmission over a data communications channel.

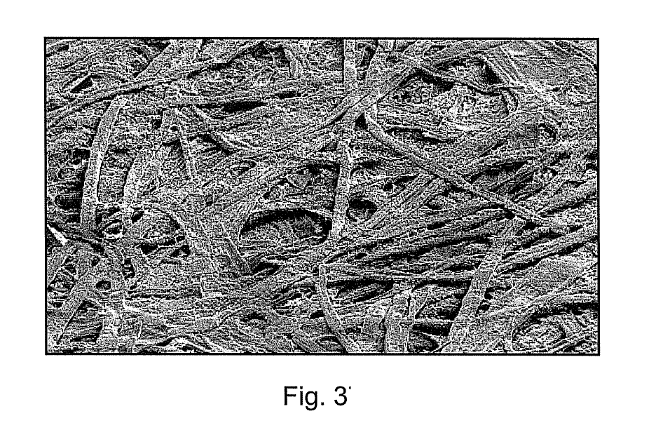

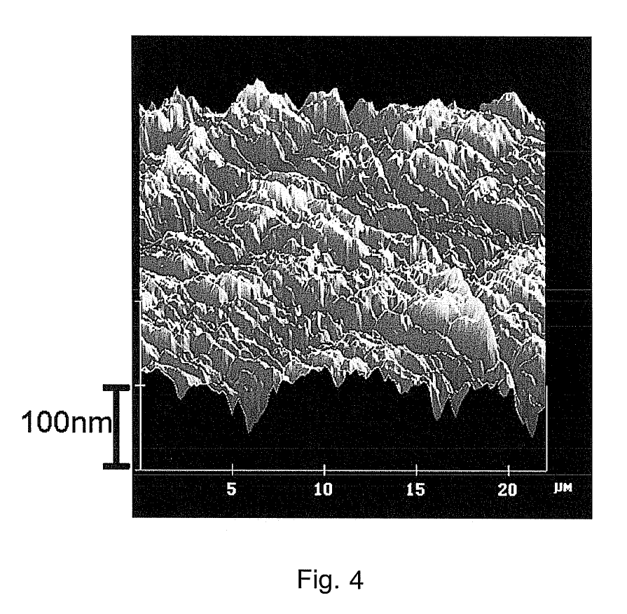

To illustrate the surface properties which the system of these examples can read, FIGS. 3 and 4 illustrate a paper and plastic article surface respectively.

FIG. 3 is a microscope image of a paper surface with the image covering an area of approximately 0.5×0.2 mm. This Figure is included to illustrate that macroscopically flat surfaces, such as from paper, are in many cases highly structured at a microscopic scale. For paper, the surface is microscopically highly structured as a result of the intermeshed network of wood or other plant-derived fibres that make up paper. The figure is also illustrative of the characteristic length scale for wood fibres which is around 10 microns. This dimension has the correct relationship to the optical wavelength of the coherent beam to cause diffraction and also diffuse scattering which has a profile that depends upon the fibre orientation. It will thus be appreciated that if a reader is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. The structure of every piece of paper is unique as a result of it being made by a process governed by laws of nature. The same applies to many other types of article.

FIG. 4 shows an equivalent image for a plastic surface. This atomic force microscopy image clearly shows the uneven surface of the macroscopically smooth plastic surface. As can be surmised from the Figure, this surface is smoother than the paper surface illustrated in FIG. 3, but even this level of surface undulation can be uniquely identified using the signature generation scheme of the present examples.

Thus, a wide variety of every day articles have unique characteristics which are measurable in a straightforward manner. It is therefore essentially pointless to go to the effort and expense of making specially prepared scan-readable tokens for the purpose of uniquely identifying articles, as is known in the prior art.

The data collection and numerical processing of a scatter signal that takes advantage of the natural structure of an article's surface (or interior in the case of transmission) is now described.

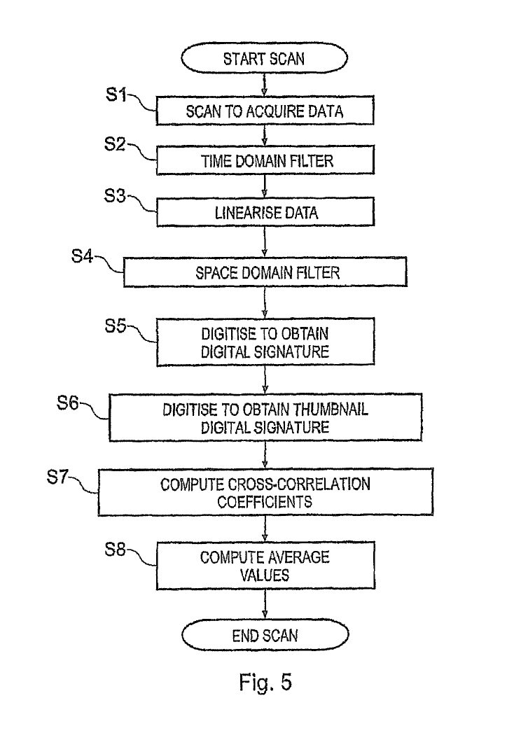

FIG. 5 shows a flow diagram showing how a signature of an article can be generated from a scan.

Step S1 is a data acquisition step during which the optical intensity at each of the photodetector elements is acquired at a number of locations along the entire length of scan. Simultaneously, an encoder signal may be acquired as a function of time, where the intensity reflected from a set of encoder markings of known spacing on the inside of the housing adjacent to the slit 10 or on the article is measured. This enables linearisation of the data collected by the photodetectors. It is noted that if the scan motor producing the required relative motion between the scan assembly and the article has a high degree of linearisation accuracy (e.g. as would a stepper motor), or if non-linearities in the data can be removed through block-wise analysis or template matching, then linearisation of the data may not be required.

Referring to FIG. 2 above, the photodetector data is acquired by the signature generator 36 taking data from the ADC 31. The number of data points per photodetector element collected in each scan is defined as N in the following. Further, the value ak(i) is defined as the i-th stored intensity value from photodetector k, where i runs from 1 to N.

Step S2 is an optional step of applying a time-domain filter to the captured data. In the present example, this is used to selectively remove signals in the 50/60 Hz and 100/120 Hz bands such as might be expected to appear if the target is also subject to illumination from sources other than the coherent beam. These frequencies are those most commonly used for driving room lighting such as fluorescent lighting.

Step S3 performs alignment of the data, including linearisation. In some examples, this step uses numerical interpolation to locally expand and contract ak(i) so that the measured encoder marking transitions are evenly spaced in time. This corrects for local variations in the motor speed and other non-linearities in the data. This step can be performed by the signature generator 36.

In some examples, where the scan area corresponds to a predetermined pattern template, the captured data can be compared to the known template and translational and/or rotational adjustments applied to the captured data to align the data to the template. This ensures that the signature of the article is read from the correct area. Also, stretching and contracting adjustments may be applied to the captured data to align it to the template in circumstances where the passage of the scan head relative to the article differs from that from which the template was constructed. Thus if the template is constructed using a defined linear scan speed, the scan data can be adjusted to match the template if the scan data was conducted with non-linearities of speed present, or at a different speed.

Step S4 applies a space-domain band-pass filter to the captured data. This filter passes a range of wavelengths in the x-direction (the direction of movement of the scan head). The filter is designed to maximise decay between samples and maintain a high number of degrees of freedom within the data. With this in mind, the lower limit of the filter passband is set to have a fast decay. This is required as the absolute intensity value from the target surface is uninteresting from the point of view of signature generation, whereas the variation between areas of apparently similar intensity is of interest. However, the decay is not set to be too fast, as doing so can reduce the randomness of the signal, thereby reducing the degrees of freedom in the captured data. The upper limit can be set high; whilst there may be some high frequency noise or a requirement for some averaging (smearing) between values in the x-direction, there is typically no need for anything other than a high upper limit. In some examples a second order filter can be used. In one example, where the speed of travel of the laser over the target surface is 20 mm per second, the filter may have an impulse rise distance 100 microns and an impulse fall distance of 500 microns.

Instead of applying a simple filter, it may be desirable to weight different parts of the filter. In one example, the weighting applied is substantial, such that a triangular passband is created to introduce the equivalent of real-space functions such as differentiation. A differentiation type effect may be useful for highly structured surfaces, as it can serve to attenuate correlated contributions (e.g. from surface printing on the target) from the signal relative to uncorrelated contributions.

Step S5 is a digitisation step where the multi-level digital signal (the processed output from the ADC) is converted to a bi-state digital signal to compute a digital signature representative of the scan. The digital signature is obtained in the present example by applying the rule: ak(i)>mean value maps onto binary ‘1’ and ak(i)<=mean value maps onto binary ‘0’. The digitised data set is defined as dk(i) where i runs from 1 to N.

The signature of the article may advantageously incorporate further components in addition to the digitised signature of the intensity data just described. These further optional signature components are now described.

Step S6 is an optional step in which a smaller ‘thumbnail’ digital signature is created. In some examples, this can be a real-space thumbnail produced either by averaging together adjacent groups of m readings, or by picking every cth data point, where c is the compression factor of the thumbnail. The latter may be preferable since averaging may disproportionately amplify noise. In other examples, the thumbnail can be based on a Fast Fourier Transform of some or all of the signature data. The same digitisation rule used in Step S5 is then applied to the reduced data set. The thumbnail digitisation is defined as tk(i) where i runs 1 to N/c and c is the compression factor.

Step S7 is an optional step applicable when multiple detector channels exist (i.e. where k>1). The additional component is a cross-correlation component calculated between the intensity data obtained from different ones of the photodetectors. With two channels there is one possible cross-correlation coefficient, with three channels up to three, and with four channels up to six, etc. The cross-correlation coefficients can be useful, since it has been found that they are good indicators of material type. For example, for a particular type of document, such as a passport of a given type, or laser printer paper, the cross-correlation coefficients always appear to lie in predictable ranges. A normalised cross-correlation can be calculated between ak(i) and al(i), where k≠l and k, l vary across all of the photodetector channel numbers. The normalised cross-correlation function is defined as:

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

Another aspect of the cross-correlation function that can be stored for use in later verification is the width of the peak of the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detector elements or an average for each detector element, such as a root mean square (rms) value of ak(i). If the detector elements are arranged in pairs either side of normal incidence, an average for each pair of detectors may be used. The intensity value has been found to be a good crude filter for material type, since it is a simple indication of overall reflectivity and roughness of the sample. For example, one can use as the intensity value the un-normalised rms value after removal of the average value, i.e. the DC background. The rms value provides an indication of the reflectivity of the surface, in that the rms value is related to the surface roughness.

The signature data obtained from scanning an article can be compared against records held in a signature database for verification purposes and/or written to such a database to add a new record of the signature to extend the existing database and/or written to the article in encoded form for later verification with or without database access.

A new database record will include the digital signature obtained in Step S5 as well as optionally its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid preliminary searching, and the rest of the data (including the thumbnails) on a main database.

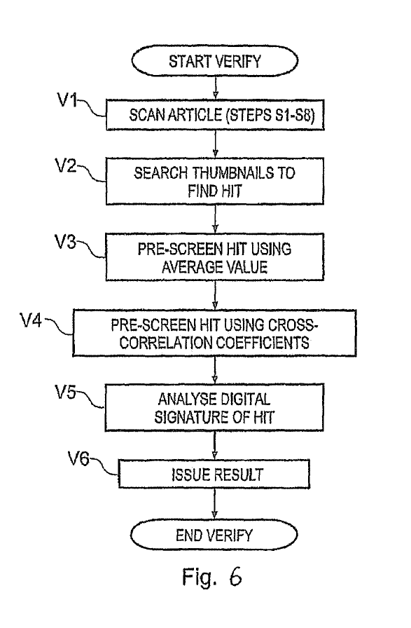

FIG. 6 is a flow diagram showing how a signature of an article obtained from a scan of an article can be verified against a signature database.

In a simple implementation, the database could simply be searched to find a match based on the full set of signature data. However, to speed up the verification process, the process of the present example uses the smaller thumbnails and pre-screening based on the computed average values and cross-correlation coefficients. To provide such a rapid verification process, the verification process is carried out in two main steps, firstly using thumbnails, in this case derived from the amplitude component of the Fourier transform of the scan data (and optionally also pre-screening based on the computed average values and cross-correlation coefficients), and secondly comparing the scanned and stored full digital signatures with each other.

Verification Step V1 in FIG. 6 is the first step of the verification or authentication process, which is to scan an article according to the process described above, i.e. to perform Scan Steps S1 to S8. This scan obtains a signature for an article which is to be validated against one or more records of existing article signatures.

Verification Step V2 seeks a candidate match using the thumbnail derived from the Fourier transform amplitude component of the scan signal, which is obtained as explained above with reference to Scan Step S6. Verification Step V2 takes each of the thumbnail entries in the database and for each evaluates the number of matching bits between it and tk(i+j), where j is a bit offset which is varied to compensate for errors in placement of the scanned area. The value of j is determined and then the thumbnail entry which gives the maximum number of matching bits. This is a ‘hit’, to be used for further, more detailed, processing. A variation on this is to pass multiple candidate matches for full testing based on the full digital signature, thereby providing several “hits”. The thumbnail selection for this can be based on any suitable criteria, such as passing up to a maximum number, for example ten, of candidate matches, each candidate match being defined as the thumbnails with greater than a certain threshold percentage of matching bits, for example 60%. In the case that there are more than the maximum number of candidate matches, only the best ten are passed on. The result of the thumbnail search is a shortlist of one or more putative matches, each of which can then be tested against the full signature.

If no candidate match is found from the thumbnails, the article is rejected (i.e. jump to Verification Step V6 and issue a fail result).

This preliminary thumbnail-based searching method employed in the present example delivers an overall improved search speed. The thumbnail is smaller than the full signature, so it takes less time to search using the thumbnail than using the full signature. Where a real-space thumbnail is used, the thumbnail needs to be bit-shifted against the stored thumbnails to determine whether a “hit” has occurred, in the same way that the full signature is bit-shifted against the stored signature to determine a match. However, where the thumbnail is based on a Fourier Transform of the signature or part thereof, further advantages may be realised as there is no need to bit-shift the thumbnails during the search. A pseudo-random bit sequence, when Fourier transformed, carries some of the information in the amplitude spectrum and some in the phase spectrum. Any bit shift only affects the phase spectrum, however, and not the amplitude spectrum. Amplitude spectra can therefore be matched without any knowledge of the bit shift. Although some information is lost in discarding the phase spectrum, enough remains in order to obtain a rough match against the database. This allows one or more putative matches to the target to be located in the database. Each of these putative matches can then be compared properly using the conventional real-space method against the new scan as with the real-space thumbnail example.

Verification Step V3 is an optional pre-screening test that may be performed before analysing the full digital signature or signatures stored in the database against the scanned digital signature. In this pre-screen, the rms values obtained in Scan Step S8 are compared against the corresponding stored values in the database records of the hit(s). A ‘hit’ is rejected from further processing if the respective average values do not agree within a predefined range. If all ‘hits’ are rejected, the article is then rejected as non-verified (i.e. jump to Verification Step V6 and issue a fail result).

Verification Step V4 is a further optional pre-screening test that may be performed before analysing the full digital signature. The cross-correlation coefficients obtained in Scan Step S7 are compared against the corresponding stored values in the database records of the hit(s). A ‘hit’ is rejected from further processing if the respective cross-correlation coefficients do not agree within a predefined range. If all ‘hits’ are rejected, the article is then rejected as non-verified (i.e. jump to Verification Step V6 and issue fail result).

Another check using the cross-correlation coefficients that might be performed in Verification Step V4 (or later) is to check the width of the peak in the cross-correlation function, where the cross-correlation function is evaluated by comparing the value stored from the original scan in Scan Step S7 above and the re-scanned value:

$${Γ}_{k , l} ( j ) = \frac{{\sum }_{i = 1}^{N} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the scanned peak is significantly larger than the width of the peaks of the ‘hits’, this may be taken as an indicator that the scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit(s). The full stored digitised signature, dkdb(i) is split into n blocks of q adjacent bits on k detector channels, i.e. there are qk bits per block. As an example, a typical value for q is 4 and a typical value for k is in the range 1 to 2, making typically 4 to 8 bits per block. The qk bits are then matched against the qk corresponding bits in the stored digital signature dkdb(i+j). If the number of matching bits within the block is greater or equal to some pre-defined threshold zthresh, then the number of matching blocks is incremented. A typical value for zthresh is 7 on a two detector system. For a one detector system (k=1), zthresh might typically have a value of 3. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of zthresh), M is the number of matching blocks and p(M) is the probability of M or more blocks matching accidentally. The value of s is determined by comparing blocks within the database from scans of different objects of similar materials, e.g. a number of scans of paper documents etc. For the example case of q=4, k=2 and zthresh=7, we find a typical value of s to be 0.1. If the qk bits were entirely independent, then probability theory would give s=0.01 for z threshold=7. The fact a higher value is found empirically is because of correlations between the k detector channels (where multiple detectors are used) and also correlations between adjacent bits in the block due to a finite laser spot width. A typical scan of a piece of paper yields around 314 matching blocks out of a total number of 510 blocks, when compared against the database entry for that piece of paper. Setting M=314, n=510 and s=0.1 for the above equation gives a probability of an accidental match of 10⁻¹⁷⁷. As mentioned above, these figures apply to a four detector channel system. The same calculations can be applied to systems with other numbers of detector channels.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification. In experiments carried out upon paper, it has generally been found that 75% of bits in agreement represents a good or excellent match, whereas 50% of bits in agreement represents no match.

By way of example, it has been experimentally found that a database comprising one million records, with each record containing a 128-bit thumbnail of the Fourier transform amplitude spectrum, can be searched in 1.7 seconds on a standard PC computer of 2004 specification. Ten million entries can be searched in 17 seconds. High-end server computers can be expected to achieve speeds up to ten times faster than this.

It will be appreciated that many variations are possible. For example, instead of treating the cross-correlation coefficients as a pre-screen component, they can be treated together with the digitised intensity data as part of the main signature. The cross-correlation coefficients could be digitised and added to the digitised intensity data, for example. The cross-correlation coefficients could also be digitised on their own and used to generate bit strings or the like which could then be searched in the same way as described above for the thumbnails of the digitised intensity data in order to find the ‘hits’.

In one alternative example, step V5 (calculation of the probability of an accidental match) can be performed using a method based on an estimate of the degrees of freedom in the system. For example, if one has a total of 2000 bits of data in which there are 1300 degrees of freedom, then a 75% (1500 bits) matching result is the same as 975 (1300×0.75) independent bits matching. The uniqueness is then derived from the number of effective bits as follows:

$$p ( m ) = {\sum }_{w = n - m}^{n} {{s}^{w} ( 1 - s )}^{n - w} {}_{w}^{n} C$$

This equation is identical to the one indicated above, except that here m is the number of matching bits and p(m) is the probability of m or more blocks matching accidentally.

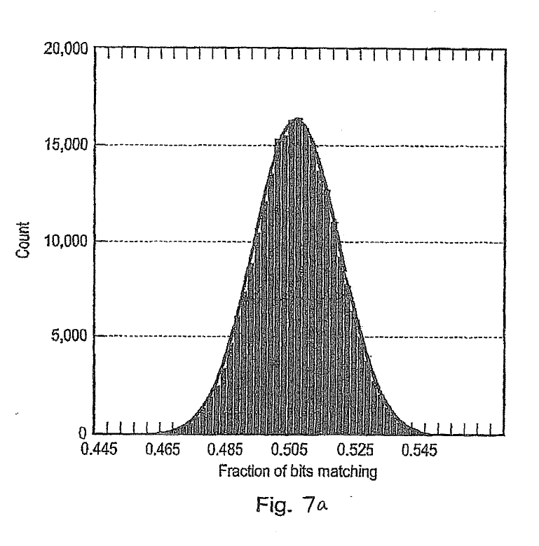

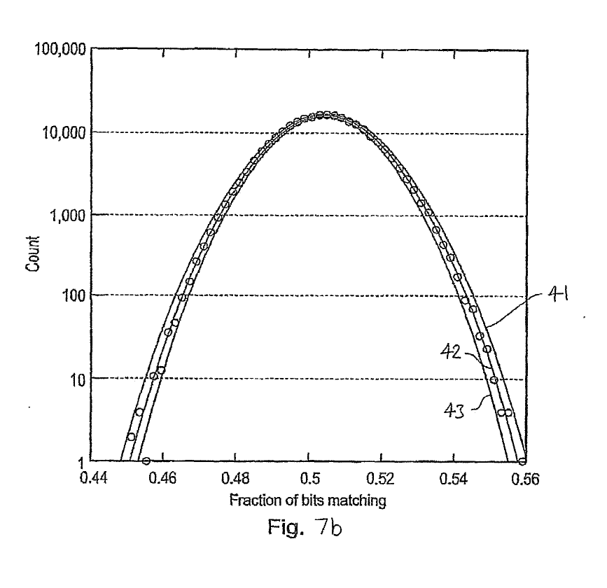

The number of degrees of freedom can be calculated for a given article type as follows. The number of effective bits can be estimated or measured. To measure the effective number of bits, a number of different articles of the given type are scanned and signatures calculated. All of the signatures are then compared to all of the other signatures and a fraction of bits matching result is obtained. An example of a histogram plot of such results is shown in FIG. 7a. The plot in FIG. 7a is based on 124,500 comparisons between 500 similar items, the signature for each item being based on 2000 data points. The plot represents the results obtained when different items were compared.

From FIG. 7a it can clearly be seen that the results provide a smooth curve centred around a fraction of bits matching result of approximately 0.5. For the data depicted in FIG. 7a, a curve can be fitted to the results, the mean of which curve is 0.504 and the standard deviation of which is 0.01218. From the fraction of bits matching plot, the number of degrees of freedom N can be calculated as follows:

$$N = μ \frac{1 - μ}{{σ}^{2}}$$

In the context of the present example, this gives a number of degrees of freedom N of 1685.

The accuracy of this measure of the degrees of freedom is demonstrated in FIG. 7b. This figure shows three binomial curves plotted onto the experimental fraction of bits matching. Curve 41 is a binomial curve with a turning point at 0.504 using N=1535, curve 42 is a binomial curve with a turning point at 0.504 using N=1685, and curve 43 is a binomial curve with a turning point at 0.504 using N=1835. It is clear from the plot that the curve 42 fits the experimental data, whereas curves 41 and 43 do not.

For some applications, it may be possible to make an estimate of the number of degrees of freedom rather than use empirical data to determine a value. If one uses a conservative estimate for an item, based on known results for other items made from the same or similar materials, then the system remains robust to false positives whilst maintaining robustness to false negatives.

FIG. 8 is a flow diagram showing the overall process of how a document is scanned for verification purposes and the results presented to a user. First the document is scanned according to the scanning steps of FIG. 5. The document authenticity is then verified using the verification steps of FIG. 6. If there is no matching record in the database, a “no match” result can be displayed to a user. If there is a match, this can be displayed to the user using a suitable user interface. The user interface may be a simple yes/no indicator system such as a lamp or LED which turns on/off or from one colour to another for different results. The user interface may also take the form of a point of sale type verification report interface, such as might be used for conventional verification of a credit card. The user interface might be a detailed interface giving various details of the nature of the result, such as the degree of certainty in the result and data describing the original article or that article's owner. Such an interface might be used by a system administrator or implementer to provide feedback on the working of the system. Such an interface might be provided as part of a software package for use on a conventional computer terminal.

When a database match is found a user may also be presented with relevant information in an intuitive and accessible form which can allow the user to apply his or her own common sense for an additional, informal layer of verification. For example, if the article is a document, any image of the document displayed on the user interface (the image of the match found in the database) should look like the document presented to the verifying person. Other factors may be of interest, such as the confidence level and bibliographic data relating to document origin. The user will be able to apply their experience to make a value judgement as to whether these various pieces of information are self-consistent.

Alternatively or additionally, the output of a scan verification operation may be fed into some form of automatic control system rather than to a human operator. The automatic control system will then have the output result available for use in operations relating to the article from which the verified (or non-verified) signature was taken.

Thus there have now been described systems and methods for scanning an article to create a signature therefrom and for comparing a resulting scan to an earlier record signature of an article to determine whether the scanned article is the same as the article from which the record signature was taken. These methods can provide a determination of whether the article matches one from which a record scan has already been made to a very high degree of accuracy.

In summary, in an example system a digital signature is obtained by digitising a set of data points obtained by scanning a coherent beam over a paper, cardboard or other article, and measuring the scatter. A thumbnail digital signature is also determined, either in real-space by averaging or compressing the data, or by digitising an amplitude spectrum of a Fourier transform of the set of data points. A database of digital signatures and their thumbnails can thus be built up. The authenticity of an article can later be verified by re-scanning the article to determine its digital signature and thumbnail, and then searching the database for a match. Searching done on the basis of the Fourier transform thumbnail improves the search speed since, in a pseudo-random bit sequence, any bit shift only affects the phase spectrum, and not the amplitude spectrum, of a Fourier transform represented in polar co-ordinates. The amplitude spectrum stored in the thumbnail can therefore be matched without any knowledge of the unknown bit shift caused by registry errors between the original scan and the re-scan.

For more details of the types of authentication system described thus far, the reader is directed to the various published patent applications identified above.

Several mentions of linearisation have been made in the preceding description. If the relative speed of the article to the sensors in the scanner is non-linear, parts of the article may appear to the scanner to be stretched or shrunk. The measured signature will be distorted as compared to the original signature in the database, making the verification process prone to errors. Where a reader is based upon a scan assembly which moves within the housing relative to an article held stationary against or in the housing, nonlinearities may arise if the motion of the scan head is not constant, such as if there are variations in the operation of the drive motor. To address this, linearisation guidance (encoder markings) can be provided within the housing. These are regularly spaced markings under the edge of the reading aperture, which can be scanned together with the article to produce indicator marks in the recorded scan. The scan data can be stretched or compressed as necessary to give these marks the same spacing as the encoder markings, thereby linearising the scan data from the article.

However, in systems where the relative motion between the article and the scan head is produced by other arrangements, non-linearities in the scan motion can be much greater, and also may not be correctable using encoder markings. Such arrangements include systems in which articles are carried past a stationary scanner by a conveyor, where the conveyor may not run at a constant speed; systems in which the user has a hand-held unit that is passed over the surface of an article; and systems in which the user holds the article and moves it through a scanner, such as in the case of a bank card passed through a swipe-type scanner.

To address recognition problems which could be caused by these non-linear effects, it is possible to adjust the analysis phase of the scan of an article to correct or compensate for the nonlinearities. For example, it is possible to use a block-wise analysis of the data involving cross-correlation of blocks in the measured signature with blocks in the database signature. Such an approach requires a substantial amount of data processing however, particularly if one or more likely candidate signatures are not selected from the database as a first step.

The present invention proposes an alternative approach to linearisation of the scan data. It is proposed to measure the instantaneous relative velocity between the article and the scan head over the course of the scan. This information is then used to correct the collected scan data for any variations in the relative velocity.

FIG. 9 shows a simplified view of part of an apparatus according to an embodiment of the invention. As with the apparatus previously described with respect to FIG. 1, the apparatus includes a scan assembly or scan head 20 inside a housing 12. The scan head 20 comprises an optical source 14 that produces a coherent laser beam 15 which is directed through a slit 10 in the housing 12 onto the surface of an article 50 outside the housing 12. The coherent light is focussed onto the article's surface by a focussing assembly 18. Typically the focal spot is elongate. At least one photodetector element 16 is arranged near the optical source to collect light scattered back from the article 50. Note that the Figure is not to scale; typically the article will be much larger in comparison to the scan head components.

To obtain a signature for the article, a set of scatter measurements is collected from an area of the surface of the article 50, which may be thought of as a scan area. Light from the optical source 14 is directed onto a first region within the scan area the article, and the light collected by the photodetectors 16 gives a first group of signals or data points corresponding to that region. Then an adjacent region is exposed to the coherent light, from which a second group of signals is collected. This is repeated for a plurality of regions across over the scan area, to give a set of data points comprising a plurality of groups of data points. The signature of the article is obtained by processing this data set, where the position of the various data points within the scan area, or correspondingly within the data set, contributes to the final result. Hence, it is important that each group of data points is correctly positioned within the data set.

One way to achieve this is to mount the scan head on a motor that scans the scan head inside the housing relative to the article at a constant velocity, so that the focussed spot of light scans across the scan area. If data groups are collected at regular time intervals, the data groups will be regularly spaced across the scan area, and the data set can be correctly assembled with appropriate regular spacing between the data groups to give the correct signature for the article. However, such an arrangement may not always be appropriate. Instead, the scanning motion can be achieved by moving the article with respect to the scan head, or moving the whole apparatus with respect to the article. These possibilities are indicated by the arrows in FIG. 9. According to the inset axes in FIG. 9, the relative motion between the article and the scan head is along the x-axis, while the long axis of the elongate focus lies along the y-axis. In such a case, the scan head is not movable within the housing. Hence, the slit 10 in the housing need only be large enough for the focussed spot to pass through; rather than large enough to expose a plurality of regions on the article as the scan head is moved.

If the relative speed between the article and the scan head varies during the scan, but the regularly collected groups of data points are still spaced evenly when assembled to form the data set, the data set will be distorted and the resulting signature will be inaccurate. This is particularly likely to happen in situations where a human operator is controlling the motion of the article or the apparatus, but can also arise in more mechanised situations, due to an inconsistent conveyor belt, for example.

The distortions in the data set can be corrected if the relative velocity during the scan is known. The positions of the groups of data within the data set can be adjusted from the default regular spacing in accordance with the velocity at which they were collected, to give a spacing that corresponds to the spacing of the regions in the scan area from which the data groups were collected. This is termed “linearisation” of the data.

The present invention proposes to obtain this velocity information by recording a sequence of images of small parts of the article's surface over the course of the scan. By appropriate image processing, the instantaneous velocity at all times during the scan can be calculated, and used to linearise the data set.

Although the images can be captured from any part of the article's surface (since all parts of the surface will be moving at the same velocity), it is convenient to utilise the slit 10 in the housing 12 for capturing the images. Otherwise, a separate imaging aperture can be provided in the housing. According to one embodiment that uses the slit 10, components for obtaining the image sequence are mounted in the housing displaced from the scan head component along the y-direction, so that the images can be recorded through an end of the slit 10.

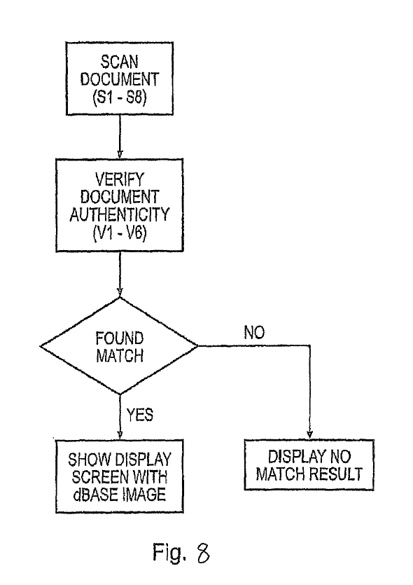

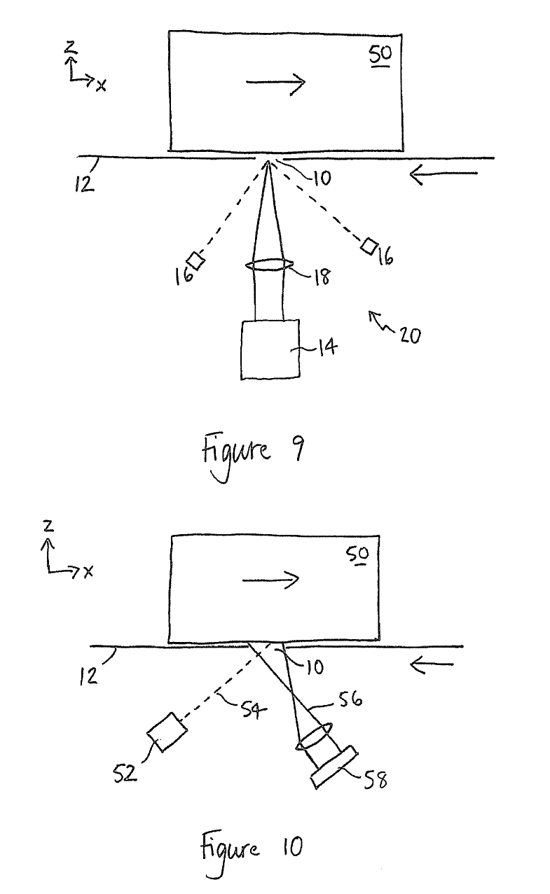

FIG. 10 shows components for imaging. A second optical source 52 is arranged to direct a beam of illuminating radiation 54 through the slit 10 and onto the surface of the article 50. Some of this light 56 will be returned from the surface, and is collected by a detector 58. Since the purpose of this arrangement is imaging, the detector 58 has a sufficient spatial extent to capture light from an area on the surface with spatial resolution. The detector may comprises an array of charge coupled devices (CCDs), or of other detector elements, for example. Similarly, the optical source 52 is arranged to illuminate an appropriately sized area of the article's surface. An area of 1 or 2 mm diameter could be used, for example. Various lenses may be included in the paths of the transmitted and returned light 54, 56 as required to facilitate illumination and collection of a focussed image.

The detector 58 is configured (under the control of a control unit or processor, such as the control unit 36 in FIG. 2) to capture images at a regular repetition rate, or frame rate, during the course of the scan. The frame rate is chosen to be high enough so that, for an expected range of typical scan velocities, a sequence of overlapping frames or images is obtained. From any two adjacent frames, the change in position of identifiable surface features within one frame as compared to the next frame can be determined, and because the time between the images in known (from the constant frame rate), the relative velocity of the article and the scan head between the times of those two images can be calculated. By making this calculation over the whole image sequence, the instantaneous velocity at all points during the scan is obtained.

The optical source 52 can be positioned so that the illuminating radiation strikes the article's surface at a low angle of incidence (grazing incidence). Such an angle might be between 5° and 25°, for example. Illuminating at a small angle highlights the microscopic surface features of the article, making it easier to identify the appearance of any particular feature in more than one frame. A larger angle could be used, though. Also, the optical source 52 may be a laser source emitting coherent radiation, or it may be a light emitting diode source (comprising one or more light emitting diodes) emitting non-coherent radiation. In the case of coherent radiation, the imaging detector may detect laser speckle or other surface information type data, rather than a more conventional image of varying intensity.

FIG. 11 shows a plan view of the slit 10 through which the elongate spot 62 of coherent radiation and the spot 64 (which can be of any shape) of illuminating radiation are emitted in a side-by-side arrangement. Alternatively, one spot could be positioned in advance of the other.

FIG. 12 shows an example illustration of a scan area 66 on the surface of an article, with an adjacent area 68 which is imaged to obtain the sequence of images. The arrow indicates the direction of relative movement. The arrangement of light spots shown in FIG. 11 will cover areas such as this. Alternatively, the illuminating light could be positioned in front of or behind the elongate spot of coherent light, in which case the imaged area will lie within the sides of the scan area.

No particular surface properties are needed for the imaged area. Any intentional surface intensity pattern could be detected by a system using incoherent radiation, but the features of the pattern will need to be very small to be encompassed within a single frame, for tracking from one frame to the next. In general, the surface microscopic features of the article will be sufficient to provide details in the images which can be followed from one frame to the next.

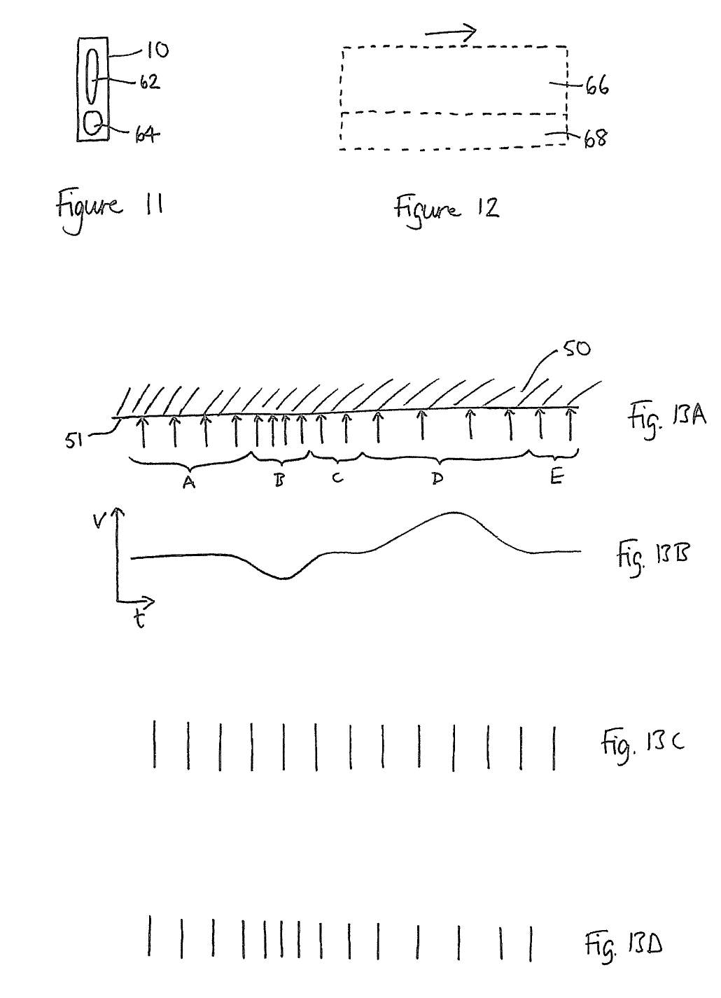

FIGS. 13A to 13D illustrate features of a method of data linearisation according to an embodiment of the invention. FIG. 13A shows a surface 51 of an article 50 from which a set of scan data has been obtained. Simultaneously, a sequence of images of the surface was recorded. The frame rate of the images was constant. However, the velocity at which the article was moved relative to the scanning apparatus was not constant. Consequently, the images within the sequence are not evenly spaced over the surface, because different distances were traversed between frames. The arrows in FIG. 13A indicate the positions of the centres of each image. Over a first part of the scan (portion A), an approximately constant velocity was achieved. Then the velocity was decreased during portion B. The distance moved between frames was therefore less, so the arrows in FIG. 13A are closer together. During the following portion C, the velocity was increased to roughly the value of the initial velocity in portion A, so the arrows are spaced further apart again. In the following portion D, the velocity was further increased. The distance traveled between frames became greater, so the spacing between the arrows is even larger. For a final portion E of the scan, the velocity dropped back to its initial level, and the arrows are spaced the same as in portion A.

The sequence of images can be processed to determine the instantaneous relative velocity throughout the scan. At higher speeds, the displacement of a given feature from one frame to the next will be large, owing to the greater distance traveled during the time for one frame. Conversely, at low speeds, the displacement between frames is small, owing to the shorter distance traveled during the time for one frame.

FIG. 13B shows a plot of the instantaneous velocity v over the course of the scan shown in FIG. 13A, indicating the slower and faster velocities in regions B and D.

Given the variation in velocity, if the set of scan data corresponding to FIG. 13A was collected at a constant rate (same time period between collection of each group of data), and then arranged with a constant spacing between groups, as shown in FIG. 13C, the date set will be distorted. The varying speed means that the data groups were not collected from evenly spaced regions of the scan area, so a regular spacing of the data groups does not properly reflect the positions within the scan area of the surface features that are represented in the collected data. For parts of the scan where the relative velocity decreased, the regions from which the data groups were collected will be closely spaced in the scan area. When the data groups from these regions are placed in the data set with the same spacing as the data groups from regions where the velocity was intermediate, the data groups are then too far apart and the scan data corresponding to these region will appear stretched. Conversely, an increase in velocity will increase the spacing between regions in the scan area, leading to a compressed portion in the data set when the default spacing is used.

The calculated instantaneous velocity can be used to correct this. The spacing of the groups of data within the data set can be adjusted to compensate for the distortions caused by the change in velocity.

As mentioned, a slow scan velocity results in a stretched data set, because the constant data group spacing in the data set is too large. The data groups should be moved closer together, so that their spacing is reduced. Similarly, a high scan velocity gives a compressed data set because the constant data groups spacing is too small. The date groups should be moved further apart, so that their spacing is increased.

FIG. 13D shows the result of this repositioning of the data groups. The groups in portion B of the scan, where the velocity was slow, have been moved closer together (smaller spacing), and the groups in portion D, where the velocity was fast, have been moved further apart (larger spacing).

From this, it can be seen that the data group spacing should be adjusted in proportion to the instantaneous velocity. A large velocity needs a large group spacing and a small velocity needs a small group spacing. The default constant spacing at every position along the whole data set can therefore be adjusted according to the instantaneous velocity at that position, such that the spacing is set in proportion to the instantaneous velocity. The value of the instantaneous velocity can be used as a scaling factor to modify the data group spacing.

This can also be used to address the average velocity of the scan, which may not be the same as the scan velocity at which the article's signature was originally read for storage in a database. Any difference will result in a signature which is overall compressed or stretched compared to the original, making comparison for authentication more difficult. Hence, information indicating the original scan velocity could be stored with the signature, and used to scale the subsequently measured scan data in the event that its scan velocity was different from the original. This could be incorporated as an offset to the scaling factor determined from the calculated instantaneous velocity, for example.

This approach could be extended to take account of any difference between the data collection rate for the original signature in the database and the data collection rate for subsequently measured scan data, for example if different apparatuses are used. The data collection rate determines the underlying spacing between the data groups in the data set (variations in instantaneous velocity aside). Thus, information pertaining to the original data collection rate can be used to scale the data group spacing to give a data set of the same extent. Similarly, if the scanning is being performed to obtain original signatures to populate a database, scaling adjustments could be made to take account of any differences in data collection rate between different apparatuses used to record the signatures.

The description thus far has assumed a constant rate of data collection and a constant imaging frame rate. This approach makes for more straightforward processing of the data. However, if desired, non-constant rates could be used, so long as the instantaneous rates are known and taken into account when calculating the instantaneous velocity and then using this to linearise the data set.

In any event, once the collected scan data has been linearised, it can then be used to generate the signature of the article, either for comparison with signatures in a database so that the authenticity of the article can be verified, or for storage into a database for future authentication of that article.

Although the technique is of relevance for linearisation of data collected by a system in which the relative motion between the article and the scan head is produced externally to the apparatus, such as scanning articles by hand, embodiments of the invention may also be utilised in a system having a drive arrangement for automatically scanning all or part of the scan head components over the scan area. Any deviations in the scan speed arising from imperfections or defects in the drive system can thereby be corrected for.

Processing a sequence of overlapping images to determine changes in position is known for optical-based computer pointing devices, or mice. In an optical mouse, an illuminating light beam is directed down onto the surface on which the mouse sits, light returned from the surface is collected as an image. Of the order of 1500 images per second are recorded when the mouse is moved over the surface. The images are processed to map the progress of features shown in the images from one image to the next. The spatial extent of the images is known, so the total distance moved by the mouse can be determined, together with the direction. This information is conveyed to the computer so that the on-screen cursor can be moved by a corresponding amount. For an optical mouse, the main parameters of interest are distance and direction, whereas in the present invention we are interested in velocity. However, the same techniques for processing the images can be employed, to determine the displacement of features from one image to the next. For example, if the image is divided into pixels, a number of shift images can be generated in which the pixels are shifted from their position in the image by different amounts. Each shift image is then compared to the preceding (unshifted) image in the sequence using cross-correlation. The shift image having the largest cross-correlation value has a shift value which matches the actual physical shift in features of the surface between the preceding image and the present image, from which the distance moved between the images can be determined. US 2002/0190953 describes this process in more detail for an optical mouse.

Detection and processing of the signature data and the imaging data may be simplified if separate optical wavelengths are used for each. If one or both of the imaging detector and the signature data collecting detector(s) are sensitive to the wavelength used for the other, filters can be used to block the non-relevant wavelengths from the detectors.

Thus, the present invention provides an improved apparatus for authentication of articles from optical scatter measurements obtained by scanning the article, in which a sequence of images of the surface of the article taken during collection of the scatter measurements is used to calculate the instantaneous velocity of the scan, and the instantaneous velocity is used to linearise the scatter measurements to correct for any variations or anomalies in the scan velocity.

1. A system for obtaining a signature from an article, the article having a scan area on a surface of the article from which a signature of the article may be read, the system comprising:
a signature generator including a scan head comprising an optical source operable to direct coherent radiation onto the scan area and a detector arrangement operable to detect the coherent radiation scattered from the scan area, the signature generator operable to generate a signature from the article by: directing coherent radiation sequentially onto a plurality of different regions in the scan area using relative motion between the scan head and the article; for each region, collecting a group of data points from signals obtained by detecting the coherent radiation scattered from that region, the groups of data points together comprising a set of data points; and determining a signature of the article from the set of data points;
a second optical source operable to direct illuminating radiation onto the surface of the article;
an imaging detector operable to receive the illuminating radiation returned from the surface of the article and to capture a sequence of images of the surface of the article during collection of the set of data points, the images captured at known times; and
a processor operable to calculate the instantaneous velocity of the relative motion between the scan head and the article during the collection of the set of data points from the captured images, and to provide the instantaneous velocity to the signature generator;
the signature generator being further operable to use the instantaneous velocity to linearise the positions of the groups of data points within the set of data points before determining the signature of the article.

2. A system according to claim 1, in which the image detector captures the images at a constant frame rate, and the groups of data points are collected at a constant rate.

3. A system according to claim 2, in which the linearisation comprises adjusting the spacing of the groups of data points within the set of data points in proportion to the calculated instantaneous velocity.

4. A system according to any claim 1, in which the instantaneous velocity and a velocity of the relative motion recorded during an earlier obtaining of a signature from an article are used to linearise the positions of the groups of data points within the set of data points.

5. A system according to claim 1, in which the illuminating radiation is coherent radiation and the imaging detector captures images of speckle.

6. A system according to claim 1, in which the second optical source comprises one or more light emitting diodes.

7. A system according to claim 1, in which the coherent radiation from the optical source and the illuminating radiation from the second optical source have different wavelengths.

8. A system according to claim 1, further comprising:
a signature comparator operable to compare the signature of the article with one or more stored signatures of articles; and
a determiner operable to determine an authentication result based on the result of the comparison by the signature comparator.

9. A method for obtaining a signature from an article, the article having a scan area on a surface of the article from which a signature of the article may be read, the method comprising:
obtaining a set of data points by: directing coherent radiation sequentially onto a plurality of different regions in the scan area using relative motion between the article and a scan head comprising an optical source operable to direct the coherent radiation onto the scan area and a detector arrangement operable to detect the coherent radiation scattered from the scan area; and, for each region, collecting a group of data points from signals obtained by detecting the coherent radiation scattered from that region, the groups of data points together comprising a set of data points;
during collection of the set of data points, directing illuminating radiation onto the surface of the article and capturing at known times a sequence of images of the surface of the article by detecting the illuminating radiation returned from the surface;
calculating the instantaneous velocity of the relative motion between the scan head and the article during the collection of the set of data points from the captured images;
using the instantaneous velocity to linearise the positions of the groups of data points within the set of data points; and
determining a signature of the article from the set of data points.

10. A method according to claim 9, in which the images are captured at a constant frame rate, and the groups of data points are collected at a constant rate.

11. A method according to claim 10, in which the linearisation comprises adjusting the spacing of the groups of data points within the set of data points in proportion to the calculated instantaneous velocity.

12. A method according to claim 9, further comprising using a velocity of the relative motion recorded during an earlier obtaining of a signature from an article to linearise the positions of the groups of data points within the set of data points.

13. A method according to claim 9, in which the illuminating radiation is coherent radiation and the captured images are images of speckle.

14. A method according to claim 9, in which the illuminating radiation is non-coherent radiation.

15. A method according to claim 9, in which the coherent radiation and the illuminating radiation have different wavelengths.

16. A method according to claim 9, further comprising:
comparing the signature of the article with one or more stored signatures of articles; and
determining an authentication result based on the result of the signature comparison.

17. A system for obtaining a signature from an article, the article having a scan area on a surface of the article from which a signature of the article may be read, the system comprising:
means for generating a signature including
means for scanning comprising
means for directing coherent optical radiation onto the scan area and
means for detecting the coherent radiation scattered from the scan area,
for generating a signature from the article by: directing coherent radiation sequentially onto a plurality of different regions in the scan area using relative motion between the scan head and the article; for each region, collecting a group of data points from signals obtained by detecting the coherent radiation scattered from that region, the groups of data points together comprising a set of data points; and determining a signature of the article from the set of data points;
means for directing illuminating radiation onto the surface of the article;
means for receiving the illuminating radiation returned from the surface of the article and for capturing a sequence of images of the surface of the article during collection of the set of data points, the images captured at known times; and
means for calculating the instantaneous velocity of the relative motion between the scan head and the article during the collection of the set of data points from the captured images, and for providing the instantaneous velocity to the signature generator;
the means for generating a signature being for using the instantaneous velocity to linearise the positions of the groups of data points within the set of data points before determining the signature of the article.
